(19) United States
(12) Patent Application Publication
(10) Pub. No.: US 2021/0051485 A1
(43) Pub. Date: Feb. 18, 2021

(54) RADIO RESOURCE MANAGEMENT (RRM) PROCEDURE IN A SHARED SPECTRUM

(71) Applicant: MEDIATEK INC., Hsinchu (TW)

(72) Inventors: Hsuan-Li LIN, Hsinchu (TW); Chiou-Wei TSAI, Hsinchu (TW); Tsang-Wei YU, Hsinchu (TW)

(73) Assignee: MEDIATEK INC., Hsinchu (TW)

(21) Appl. No.: 16/986,614

(22) Filed: Aug. 6, 2020

Related U.S. Application Data
(60) Provisional application No. 62/888,136, filed on Aug. 16, 2019.

(51) Int. Cl. H04W 16/14; H04L 5/00; H04W 24/08; H04W 72/00; H04W 56/00; H04W 72/08; H04W 72/04

(52) U.S. Cl. CPC H04W 16/14; H04L 5/0048; H04W 24/08; H04W 74/0808; H04W 56/001; H04W 72/085; H04W 72/0446; H04W 72/005

(57) ABSTRACT

Aspects of the disclosure provide a method and an apparatus. For example, the apparatus can include receiving circuitry and processing circuitry. The receiving circuitry can be configured to receive from a cell a Q number and one or more SSBs within DRS transmission windows associated with the cell. The processing circuitry can be configured to, for each of the DRS transmission windows, perform a modulo operation on position indexes of the SSB with the Q number to determine SSB beam indexes (SBIs) of the SSBs. A remainder of each of the position indexes is an SBI of one of the SSBs that corresponds to the position index. The processing circuitry can be further configured to combine RRM measurements of the SSBs within the DRS transmission windows based on the SBIs of the SSBs to determine the quality of the cell.

### INCORPORATION BY REFERENCE

This present disclosure claims the benefit of U.S. Provisional Application No. 62/888,136, “RRM and RLM Procedures in NR-U” filed on Aug. 16, 2019, which is incorporated herein by reference in its entirety.

### TECHNICAL FIELD

The present disclosure relates to wireless communications, and, more particularly, to performing a radio resource management (RRM) procedure in a shared spectrum.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In a New Radio-unlicensed (NR-U) wireless communication system, a user equipment (UE) can perform data transmission and reception with a cell operating in an NR-U frequency band. For example, the UE can receive synchronization signal blocks (SSBs) from the cell, combine radio resource management (RRM) measurements of the SSBs, and report the quality of the cell.

### SUMMARY

Aspects of the disclosure provide a method, which can include receiving, at a user equipment (UE), a Q number indicating a quasi co location (QCL) relation for synchronization signal block (SSB) position for a cell operating in a shared spectrum, receiving, at the UE, from the cell operating in the shared spectrum one or more SSBs within discovery reference signal (DRS) transmission windows associated with the cell. The method can further include, for each of the DRS transmission windows, performing a modulo operation on position indexes of the SSB within a corresponding DRS transmission window with the Q number to determine SSB beam indexes (SBIs) of the SSBs. A remainder of each of the position indexes can be an SBI of one of the SSBs that corresponds to the position index. The method can further include combining radio resource management (RRM) measurements of the SSBs within the DRS transmission windows based on the SBIs of the SSBs within the DRS transmission windows to determine the quality of the cell operating in the shared spectrum. In some embodiments, receiving a Q number includes receiving a PBCH that carries the Q number from the cell operating in the shared spectrum in a case that the UE has no serving cell, and receiving a higher layer signaling that carries the Q number from a serving cell in a case that the UE has the serving cell.

In an embodiment, receiving a Q number can include receiving a physical broadcast channel (PBCH) that carries the Q number. For example, the Q number can be carried in a master information block (MIB) of the PBCH. In another embodiment, receiving a PBCH that carries the Q number can include receiving the PBCH that carries the Q number for the cell operating in the shared spectrum. In yet another embodiment, receiving a PBCH that carries the Q number can include receiving the PBCH that carries the Q number from the cell operating in the shared spectrum.

In some embodiments, receiving a Q number can include receiving a higher layer signaling that carries the Q number. For example, the higher layer signaling can be a measurement configuration message including a measurement object (MO) that carries the Q number. The MO can further carries a carrier frequency, and the Q number can be applied for all cells operating in the shared spectrum. For another example, the higher layer signaling is a system information block (SIB) that carries the Q number. In some embodiments, receiving the higher layer signaling that carries the Q number can include receiving the higher layer signaling that carries the Q number for the cell operating in the shared spectrum. In other embodiments, receiving the higher layer signaling that carries the Q number can include receiving the higher layer signaling that carries the Q number from a serving cell. For example, the serving cell is different from the cell operating in the shared spectrum.

Aspects of the disclosure provide an apparatus, which can include receiving circuitry and processing circuitry. The receiving circuitry can be configured for receiving a Q number indicating a QCL relation for SSB positions for a cell operating in a shared spectrum and one or more SSBs within DRS transmission windows associated with the cell. The processing circuitry can be configured for, for each of the DRS transmission windows, performing a modulo operation on position indexes of the SSBs within a corresponding DRS transmission window with the Q number to determine SBIs of the SSBs within the corresponding DRS transmission window. A remainder of each of the position indexes can be an SBI of one of the SSBs that corresponds to the position index. The processing circuitry can further be configured for combining RRM measurements of the SSBs within the DRS transmission windows based on the SBIs of the SSBs within the DRS transmission windows to determine a quality of the cell operating in the shared spectrum.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary beam-based wireless communication system according to some embodiments of the disclosure;

FIG. 2 shows an exemplary dual-connectivity wireless communication system according to some embodiments of the disclosure;

FIG. 3 shows an exemplary sequence of SSBs received at UE within discovery reference signal (DRS) transmission windows from a cell operating in a shared spectrum according to some embodiments of the disclosure;

FIG. 4 shows a flow chart of an exemplary method according to some embodiments of the disclosure; and

FIG. 5 shows a functional block diagram of an exemplary apparatus according to some embodiments of the disclosure.

### DETAILED DESCRIPTION OF EMBODIMENTS

License-assisted access (LAA) can support unlicensed frequency bands as a complement to licensed frequency bands. In order to fairly share the radio resources among systems or operators, the LAA technique can include a listen-before-talk (LBT) mechanism. As a base station (BS) cannot transmit reference signals (e.g., synchronization signals (SSs)) to a user equipment (UE) until the LBT procedure is performed successfully, a Q number of SS blocks (SSBs) are allowed to be transmitted at any consecutive beam positions within a discovery reference signal (DRS) transmission window. The UE has to assume the Q number in order to calculate the SSB beam indexes (SBIs) of the SSBs and combine radio resource managements (RRM) measurements of the SSBs based on the SBIs. However, if the assumed Q number is greater or less than the actual Q number, the RRM measurements of the SSBs thus combined are not accurate. According to some embodiments of the disclosure, the UE can calculate the SBIs of the SSBs with the actual Q number that is preconfigured to the UE.

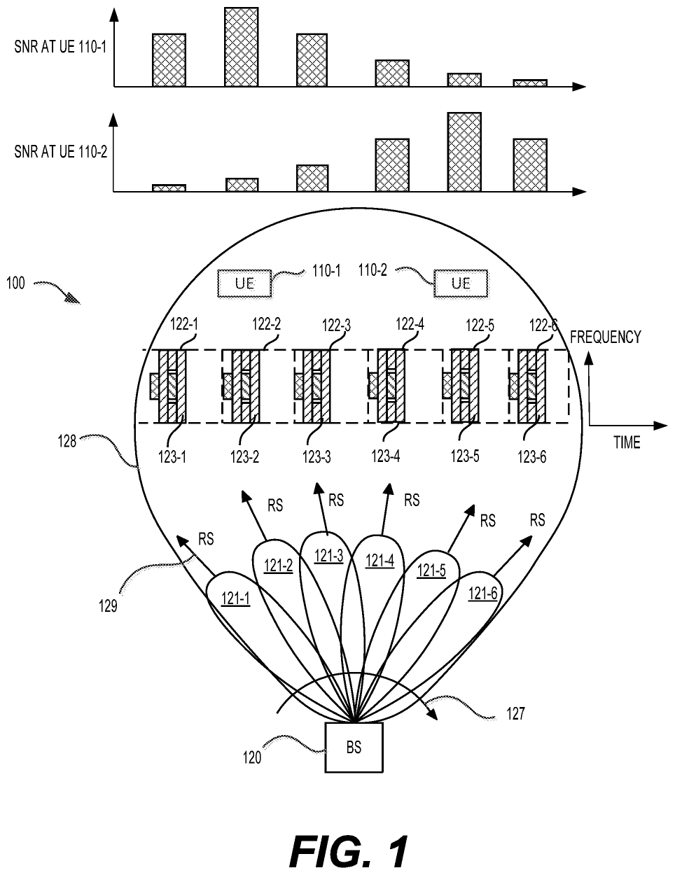

FIG. 1 shows an exemplary beam-based wireless communication system 100 according to some embodiments of the disclosure. The wireless communication system 100 can include user equipment (UEs) 110-1 and 110-2 and a base station (BS) 120. The wireless communication system 100 can employ 5th generation (5G) wireless communication technologies developed by the 3rd Generation Partnership Project (3GPP). Further, the wireless communication system 100 can employ beam-based technologies other than technologies developed by 3GPP.

Millimeter Wave (mm-Wave) frequency bands and beamforming technologies can be employed in the wireless communication system 100. Accordingly, the UE 110 and the BS 120 can perform beamformed transmission or reception. In beamformed transmission, wireless signal energy can be focused on a specific direction to cover a target serving region. As a result, an increased antenna transmission (Tx) gain can be achieved in contrast to omnidirectional antenna transmission. Similarly, in beamformed reception, wireless signal energy received from a specific direction can be combined to obtain a higher antenna reception (Rx) gain in contrast to omnidirectional antenna reception. The increased Tx or Rx gain can compensate path loss or penetration loss in mm-Wave signal transmission.

The BS 120 can be a base station implementing a gNB node as specified in 5G NR air interface standards developed by 3GPP. The BS 120 can be configured to control one or more antenna arrays to form directional Tx or Rx beams for transmitting or receiving wireless signals. In some embodiments, different sets of antenna arrays are distributed at different locations to cover different serving areas. Each set of antenna arrays can be referred to as a transmission reception point (TRP).

In the example shown in FIG. 1, the BS 120 can control a TRP to form Tx beams 121-1 to 121-6 to cover a cell 128. The beams 121-1 to 121-6 can be generated towards different directions. The beams 121-1 to 121-6 can be generated simultaneously or in different time intervals in different examples. In an embodiment, the BS 120 is configured to perform a beam sweeping 127 to transmit downlink L1/L2 control channel and/or data channel signals. During the beam sweeping 127, Tx beams 121-1 to 121-6 towards different directions can be successively formed in a time division multiplex (TDM) manner, such as time intervals 122-1 to 122-6, which include synchronization signal blocks (SSBs) 123-1 to 123-6, respectively, to cover the cell 128. During each of the time intervals 122-1 to 122-6 for transmission of one of the beams 121-1 to 121-6, a set of L1/L2 control channel data and/or data channel data can be transmitted with the respective Tx beam. The beam sweeping 127 can be performed repeatedly with a certain periodicity. In alternative embodiments, the beams 121-1 to 121-6 may be generated in a way other than performing a beam sweeping. For example, multiple beams towards different directions may be generated at a same time. In other embodiments, different from the example shown in FIG. 1, where the beams 121-1 to 121-6 are generated vertically, the BS 120 can generate beams towards different horizontal or vertical directions. In an embodiment, the maximum number of beams generated from a TRP can be 64.

Each of the beams 121-1 to 121-6 can be associated with various reference signals (RSs) 129, such as channel-state information reference signal (CSI-RS), demodulation reference signal (DMRS), and the synchronization signals (SSs) 123-1 to 123-6 (e.g., primary synchronization signal (PSS) and secondary synchronization signal (SSS)). Those RSs can serve for different purposes depending on related configurations and different scenarios. For example, some RSs can be used as beam identification RSs for purpose of identifying a beam, and/or beam quality measurement RSs for monitoring beam qualities. Each of the beams 121-1 to 121-6, when transmitted at different occasions, may carry different signals, such as different L1/L2 data or control channels, or different RSs.

In an embodiment, the beams 121-1 to 121-6 of the cell 128 can be associated with synchronization signal blocks (SSBs) (also referred to as SS/PBCH blocks) 123-1 to 123-6. For example, each of the SS blocks 123-1 to 123-6 can include SSs (e.g., PSS, SSS) and a physical broadcast channel (PBCH) carried on several consecutive orthogonal frequency division multiplexing (OFDM) symbols in an OFDM based system. For example, the BS 120 may periodically transmit a sequence of SSBs (referred to as an SSB burst set). The SSB burst set may be transmitted by performing a beam sweeping. For example, each of the SSBs 123-1 to 123-6 of the SSB burst set is transmitted using one of the beams 121-1 to 121-6. The sequence of SSBs 123-1 to 123-6 may each carry an SSB beam index (SBI) indicating a timing or location of each SSB among the sequence of SSBs 123-1 to 123-6.

The UE 110 can evaluate the quality of the beams 121-1 to 121-6 by measuring, for example, their signal to noise ratios (SNRs), which are the average of the received power on the SSBs 123-1 to 123-6 divided by noises, and determine the suitable beam(s). For example, the UE 110-1 can select the beam 121-2 as the suitable beam, while the UE 110-2 can select the beam 121-5 as the suitable beam.

The UE 110 can be a mobile phone, a laptop computer, a vehicle carried mobile communication device, a utility meter fixed at a certain location, and the like. Similarly, the UE 110 can employ one or more antenna arrays to generate directional Tx or Rx beams for transmitting or receiving wireless signals. While only the UE 110 is shown in FIG. 1, some other UEs can be distributed within or outside of the cell 128, and served by the BS 120 or other BSs not shown in FIG. 1. In the example shown in FIG. 1, the UE 110 is within the coverage of the cell 128.

The UE 110 can operate in radio resource control (RRC) connected mode, RRC inactive mode, or RRC idle mode. For example, when the UE 110 is operating in RRC connected mode, an RRC context is established and known to both the UE 110 and the BS 120. The RRC context includes parameters necessary for communication between the UE 110 and the BS 120. An identity of the UE 110, such as a cell radio network temporary identified (C-RNTI), can be used for signaling between the UE 110 and the BS 120.

When the UE 110 is operating in RRC idle mode, there is no RRC context established. The UE 110 does not belong to a specific cell. For example, no data transfer may take place. The UE 110 sleeps most of the time in order to save power, and wakes up according to a paging cycle to monitor if a paging message is coming from the network side of the wireless communication system 100. Triggered by a paging message (e.g., system information updating, or a connection establishment request), the UE 110 may transfer from RRC idle mode to RRC connected mode. For example, the UE 110 can establish uplink synchronization, and an RRC context can be established in both the UE 110 and the BS 120.

When the UE 110 is operating in RRC inactive mode, RRC context is maintained by the UE 110 and the BS 120. However, similar to RRC idle mode, the UE 110 may be configured with discontinuous reception (DRX). For example, the UE 110 sleeps most of the time in order to save power, and wakes up according to a paging cycle to monitor paging transmission. When triggered, the UE 110 can promptly transition from RRC inactive mode to RRC connected mode to transmit or receive data with fewer signaling operations than a transition from RRC idle mode to RRC connected mode.

In some embodiments, the wireless communication system 100 can employ carrier aggregation (CA) to increase the data rate of the UE 110. In CA, two or more component carriers (CCs) can be aggregated, and the UE 110 can simultaneously receive or transmit on one or more CCs, depending on its capabilities. CA can be implemented by aggregating contiguous CCs within the same frequency band, so called intra-band contiguous aggregation, by aggregating non-contiguous CCs within the same frequency band, so called intra-band non-contiguous aggregation, or by aggregating non-contiguous CCs within different frequency bands, so-called inter-band aggregation. CCs can be organized into multiple cells, including one primary cell (PCell) (e.g., the cell 128) and one or more secondary cells (SCells). During an RRC connection establishment/re-establishment/handover procedure, a cell providing NAS mobility information can be a serving cell. For example, the serving cell can denote a PCell. In the example shown in FIG. 1, the UE 110 is within the coverage of the cell 128. In some embodiments, the UE 110 may be distributed outside of the cell 128, for example, distributed within one of the secondary cells (SCells) or within a neighboring cell.

In some embodiment, the wireless communication system 100 can also employ a license-assisted access (LAA) technique, where the CA technique is employed to aggregate downlink carriers in unlicensed frequency bands, primarily in the 5 GHz range, with carriers in licensed frequency bands. The unlicensed frequency bands can act as a complement to offer higher data rates. Mobility, critical control signaling, and services demanding high quality of service (QoS) can rely on carriers in the licensed frequency band, while less demanding traffic can be handled by the carriers using unlicensed frequency bands. With regard to a frequency band from 3 to 6 GHz, the maximum number of beams generated from a TRP can be up to 8. For example, the number of beams generated from a TRP for the 5 GHz unlicensed frequency band can be 1, 2, 4 or 8.

In order to fairly share the radio resources among systems or operators, the LAA technique can include a listen-before-talk (LBT) mechanism. For example, the BS 120 has to first listen or sense the carrier frequency before it can perform data transmission.

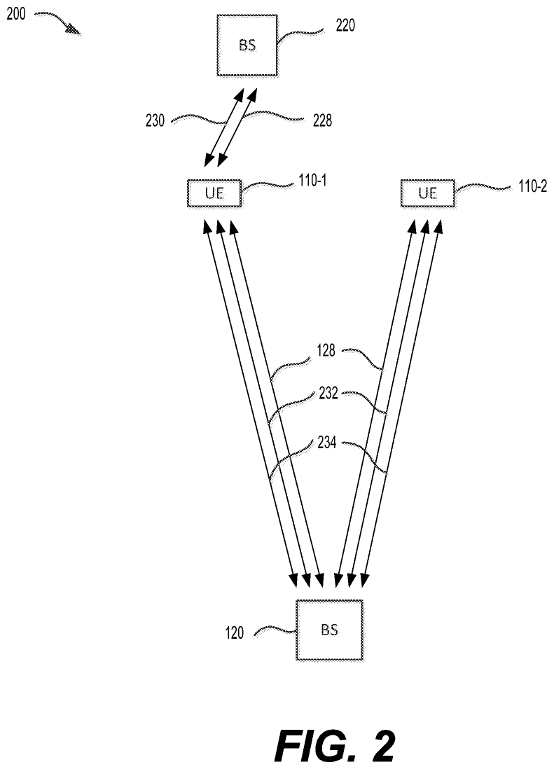

FIG. 2 shows an exemplary dual-connectivity wireless communication system 200 according to some embodiments of the disclosure. For example, the wireless communication system 200 can include the UEs 110-1 and 110-2, the BS 120, and another BS 220, the BS 220 can also control a TRP to form Tx beams to cover another cell 228, and the UE 110-1 can be simultaneously connected to the BS 120 (e.g., a master BS) and the BS 220 (e.g., a secondary BS 220). The master BS 120 can provide the control plane connection to a core network. The secondary BS 220, with no control plane connection to the core network, can provide additional resources to the UE 110-1. CA can be used in the BSs 120 and 220. For example, the master BS 120 is responsible for scheduling transmission in a master cell group (MSG), and the secondary BS 220 can handle a secondary cell group (SCG). Each of MSG and SCG can include one primary cell and one or more secondary cells. In the example shown in FIG. 2, the MSG can include one primary cell (PCell) 128 and two secondary cells (SCells) 232 and 234 that are united together by CA, and the SCG can include one primary secondary cell (PSCell) 228 and one secondary cell (SCell) 230 that are also united together by CA. The PCell and the PSCell can be used to initiate an initial access to the BS 120 and the BS 220, respectively, and are collectively called sPCell.

3GPP provides radio resource management (RRM) to ensure that the UE 110 can maintain robust and reliable connection(s) to the BSs 120 and 220. The RRM may encompass a wide range of techniques and procedures, including cell search, cell reselection, handover, radio link or connection monitoring, and connection establishment and re-establishment. For example, for the purpose of handover to a neighboring cell or adding a new CC in the CA, the UE 110 is required to conduct RRM measurements on the neighboring cell for its cell quality using reference signal received power (RSRP) or reference signal received quality (RSRQ) metrics, and report measurement results to its serving cell (e.g., the PCell 128). The UE 110 may continuously perform the RRM measurement to monitor cell qualities of the cells 128, 232, 234, 228 and 230 as well as neighboring cells. When the quality of a neighboring cell (i.e., a target cell) becomes better than that of the serving cell 128, the UE 110 may perform a handover procedure from the serving cell 128 to the target cell.

Based on a set of measurement configurations received from the serving cell 128, the UE 110 can perform a measurement procedure to measure the serving cell 128 and neighboring cells, and transmit a measurement repot to the BS 120. For example, the measurement configuration can be transmitted to the UE 110 via a radio resource control (RRC) signaling. In an embodiment, the measurement can be performed based on reference signals transmitted from the BS 120. In NR, the cell quality can be measured by using SSBs. The network can configure the UE 110 to report measurement information to support the control of UE mobility. The measurement configuration may specify a set of to-be-measured intra-frequency layers (with serving/neighboring cells), inter-frequency layers (with neighboring cells), and inter-radio access technology (RAT) frequency layers (with neighboring cells). The measurement configuration can be signaled via the RRCConnectionReconfiguration message, and include measurement objects (MOs), reporting configurations, measurement identities, quantity configurations, measurement gaps, and the like. The MO defines on what the UE 110 should perform the measurement, such as a carrier frequency. The MO may include a list of cells to be considered (a white-list or black-list) as well as associated parameters, e.g., frequency- or cell-specific offsets. The measurement quantities may include reference signal received power (RSRP), reference signal received quality (RSRQ), signal-to-noise and interference ratio (SINR), reference signal time difference (RSTD), and the like.

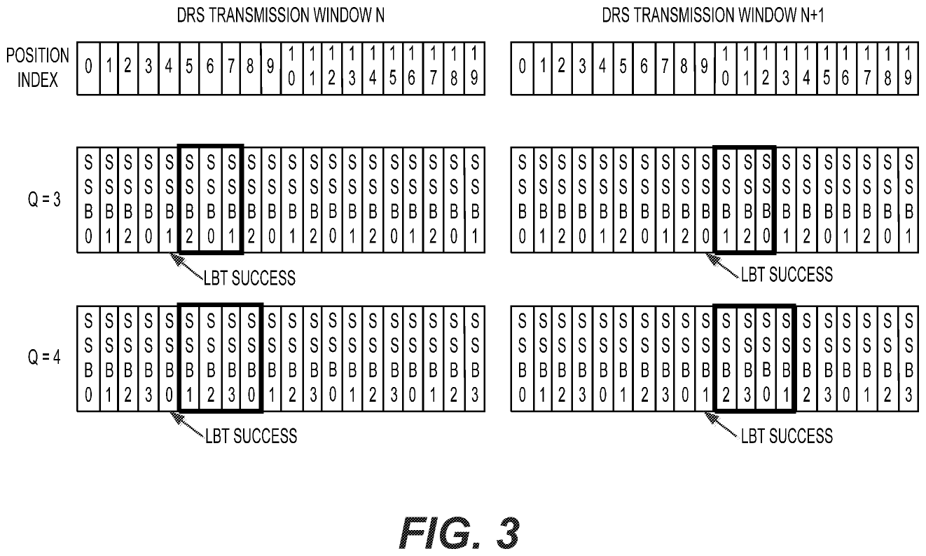

FIG. 3 shows an exemplary sequence of SSBs #0, #1 and #2 (or #0, #1, #2 and #3) received at the UE 110 within discovery reference signal (DRS) transmission windows N and N+1 from a cell operating in a shared spectrum according to some embodiments of the disclosure. For example, the shared spectrum can be a New Radio-unlicensed (NR-U) frequency band. The UE 110 can determine the quality of the cell by measuring the SSBs. The length of each of the DRS transmission windows N and N+1 is 5 ms, and the subcarrier spacing (SCS) is 30 KHz. As mentioned previously, the BS 220, if operating in an unlicensed frequency band, has to first perform the LBT procedure to listen or sense the carrier frequency in order to compete with other operators or systems for the opportunity to occupy a transmission channel and perform data transmission on the transmission channel. As shown in the example of FIG. 3, the BS 220 cannot transmit a SSB burst to the UE 110-1 until the LBT is performed successfully. As the LBT may be successful at different occasions, a Q number of consecutive SSBs may be distributed at different beam positions within different DRS transmission windows. For example, the three (Q=3) of consecutive SSBs (with SSB beam indexes (SBIs) #2, #0 and #1, respectively) are transmitted within the DRS transmission window N at beam positions corresponding to position indexes #5-7 as the LBT is successful at position index #4, while the other three of consecutive SSBs (with SBIs #1, #2 and #0, respectively) are transmitted within the DRS transmission window N+1 at beam positions corresponding to position indexes #10-12 as the LBT is successful at position index #9. Although the SSBs shown in FIG. 3 are consecutive and in the number of the Q number, they can be inconsecutive and in other numbers in other embodiments.

After the LBT is successful, the UE 110-1 can start receiving a Q number of consecutive SSBs within the DRS transmission windows N and N+1. The UE 110-1 can then decode the received SSBs to obtain the position indexes corresponding to the SSBs. For example, the UE 110-1 can decode physical broadcast channel (PBCH)/demodulation reference signal (DMRS) of the SSBs for the three least significant bits (LSBs) of the position index and decode the PBCH/master information block (MIB) for another two bits of the position index. In the example shown in FIG. 3, the UE 110-1 can obtain the position indexes #5, #6 and #7 corresponding to the SSBs within the DRS transmission window N, and the position indexes #10, #11 and #12 corresponding to the SSBs within the DRS transmission window N+1.

The UE 110-1 can then perform a modulo operation on the position indexes with the Q number to determine the SBIs of the SSBs. The remainder of each of the position indexes is an SBI of the corresponding one of the SSBs. For example, mod (the position index #5, Q number=3) is 2, which is the SBI of the SSB (SSB #2) received at the beam position corresponding to the position index #5. For another example, mod (the position index #11, Q number=4) is 3, which is the SBI of the SSB (SSB #3) received at the beam position corresponding to the position index #11 within the DRS transmission window N+1.

The UE 110-1 can then combine RRM measurements of the SSBs within the DRS transmission windows based on the SBIs of the SSBs within the DRS transmission windows to determine the quality of the cell 228. For example, the UE 110-1 can average the RRM measurements of the SSB #0, #1 and #2 within the DRS transmission windows N and the SSB #0, #1 and #2 within the DRS transmission windows N+1, respectively, and determine the quality of the cell 228 based on the averaged RRM measurements.

The above steps are performed based on an assumption that the Q number is known to the UE 110-1. Without the knowledge of the Q number, the UE 110-1 has to assume a Q number on its own in order to determine the SBIs of the SSBs. For example, if the UE 110-1 assumes a Q number of 8, which is greater than the actual Q number of 3, the actual SSBs #2, #0 and 1 within the DRS transmission window N and the actual SSBs #1, #2 and #0 within the DRS transmission window N+1 will be mistaken as SSBs #5, #6 and #7 and SSBs #2, #3 and #4, respectively. Therefore, the UE 110-1 will report the RRM measurements of as many as the six mistaken SSBs, three of which should have been combined with the respective other three. In view of the combination of the RRM measurements of the mistaken SSBs #5, #6 and #7, some samples (i.e., the mistaken SSBs #2, #3 and #4) are missing, and vice versa. For another example, if the UE 110-1 assumes a Q number of 2, which is less than the actual Q number of 4, the actual SSBs #1 and #3, which are distinct from each other, will be mistaken as the same SSB, and their RRM measurements will be combined. Therefore, the quality of the cell 228 determined in such a way is not accurate, or even worthless.

Methods are proposed according to some embodiments of the disclosure to allow the UE 110 to get to know the Q number in order to combine the RRM measurements of the SSBs properly. The UE 110 can get to know the Q number in a variety of ways.

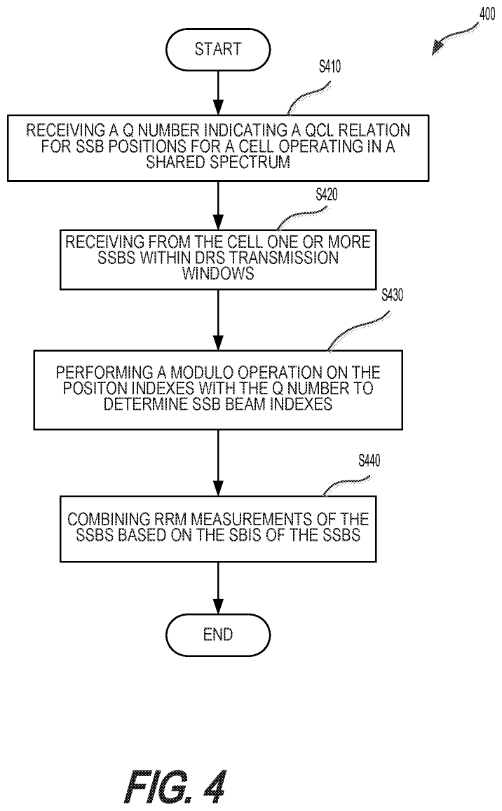

FIG. 4 shows a flow chart of an exemplary method 400 according to some embodiments of the disclosure. In various embodiments, some of the steps of the method 400 shown can be performed concurrently, in a different order than shown, can be substituted for by other method step, or can be omitted. Additional method steps can also be performed as desired. Aspects of the method 400 can be implemented by a wireless device, such as the UE 110 illustrated in and describe with respect to the preceding figures.

At step S410, the UE 110 can receive a Q number indicating a quasi co location (QCL) relation of SSB positions for a cell operating in a shared spectrum. In some embodiments, the shared spectrum can be an NR-U frequency band. In other embodiments, the Q number is ssbPositionQCL-Relationship specified in 3GPP TS 38.213 V16.0.0. In an embodiment, the UE 110 can receive the Q number by receiving a PBCH that carries the Q number from the cell operating in the shared spectrum in a case that the UE 110 has no serving cell. In another embodiment, the UE 110 can receive the Q number by receiving a higher layer signaling that carries the Q number from a serving cell in a case that the UE 110 has the serving cell. In other embodiments, the UE 110, when operating in an RRC-idle mode and performing a cell selection procedure, can receive a Q number by receiving a PBCH that carries the Q number, and decode the PBCH to obtain the Q number. For example, the Q number can be carried in a master information block (MIB) of the PBCH. For example, SubcarrierSpacingCommon (1 bit) and the least significant bit (LSB) of ssb-SubcarrierOffset (1 bit) can be used to carry the Q number. For another example, SubcarrierSpacingCommon (1 bit) and the spare bit (1 bit) can be used to carry the Q number. In various embodiments, the UE 110 can receive the PBCH that carries the Q number by receiving the PBCH that carries the Q number for the cell operating in the shared spectrum. In another embodiment, the UE 110 can receive the PBCH that carries the Q number by receiving the PBCH that carries the Q number from the cell operating in the shared spectrum.

In some embodiments, the UE 110, when operating in an RRC-connected mode and performing a cell re-selection procedure, can receive the Q number by receiving a higher layer signaling that carries the Q number from a serving cell. For example, the higher layer signaling can be a measurement object (MO) that carries the Q number. For example, the MO can further carry a carrier frequency, and the Q number can be applied to all cells operating at the carrier frequency, for example, an SCell and a PSCell operating at the carrier frequency. For another example, the higher layer signaling can be a system information block (SIB) (e.g., SIB 2) that carries the Q number. In another embodiment, the Q number can be carried in remaining minimum system information (RMSI) of the SIB (e.g., SIB 1), and the UE 110 can decode the PBCH to obtain the Q number by decoding the RMSI of the PBCH. In other embodiments, the UE 110 can receive the higher layer signaling that carries the Q number by receiving the higher layer signaling that carries the Q number for the cell operating in the shared spectrum. In various embodiments, the UE 110 can receive the higher layer signaling that carries the Q number by receiving the higher layer signaling that carries the Q number for a serving cell. For example, the serving cell can be the same as or different from the cell operating in the shared spectrum

At step S420, the UE 110 can receive from the cell operating in the shared spectrum one or more SSBs within DRS transmission windows associated with the cell. In some embodiments, the SSBs can be consecutive. In other embodiments, the SSBs can be in the number of the Q number. Each of the DRS transmission windows can include a sequence of beam positions each corresponding to a position index, and the SSBs within each of the DRS transmission windows can be transmitted at the same or different beam positions for different DRS transmission windows. In an embodiment, the Q number can be a preconfigured number (e.g., a default Q number) preconfigured to the UE 110. For example, the Q number can be 1, 2, 4 or 8. When the Q number is 1, the UE 110 will not expect to be configured with two Type-0 PDCCH monitoring occasions in a slot. When performing an initial cell search procedure, the UE 110 can assume the Q number of 8. In an embodiment, the UE 110 can receive a number of SSBs less than the Q number within a DRS transmission window. In some embodiments, for each of the DRS transmission windows, the UE 110 can decode the SSBs to obtain position indexes corresponding to the SSBs. For example, the UE 110 can decode the PBCHs of the SSBs to obtain the position indexes corresponding to the SSBs.

In another embodiment, before receiving the SSBs, the UE 110 can be just powered on and performing a cell search procedure, and the cell can be a PCell. In some embodiments, when receiving the SSBs, the UE 110 can be in an RRC-connected mode and performing a cell re-selection procedure, and the cell can be an SCell or a PSCell. In other embodiments, when receiving the SSBs, the UE 110 can be in an RRC-idle mode and performing a cell selection procedure, and the cell can be an SCell or a PSCell.

At step S430, for each of the DRS transmission windows, the UE 110 can perform a modulo operation on the position indexes of the SSBs within a corresponding DRS transmission window with the Q number to determine SBIs of the SSBs within the corresponding DRS transmission window. The remainder of each of the position indexes can be an SBI of one of the SSBs that corresponds to the position index.

At step S440, the UE 110 can combine RRM measurements of the SSBs within the DRS transmission windows based on the SBIs of the SSBs within the DRS transmission windows to determine the quality of the cell operating in the shared spectrum. As the Q number is known to the UE 110, the UE 110 can obtain the correct SBIs corresponding to the SSBs by using the Q number, and report the quality of the cell to the serving cell.

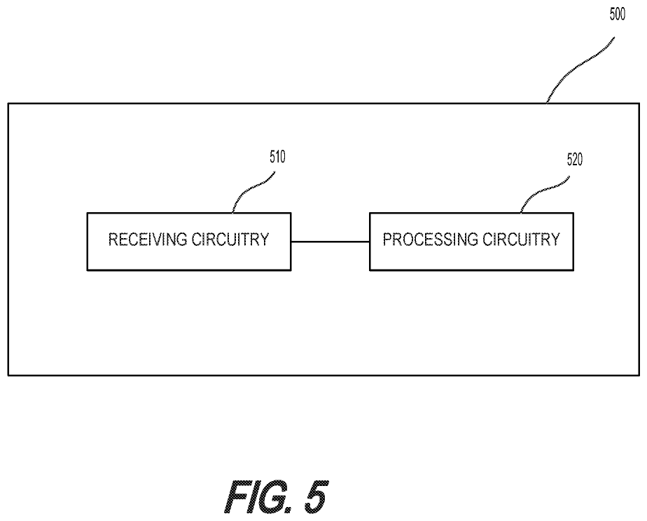

FIG. 5 shows a functional block diagram of an exemplary apparatus 500 according to some embodiments of the disclosure. The apparatus 500 can be configured to perform various functions in accordance with one or more embodiments or examples described herein. Thus, the apparatus 500 can provide means for implementation of techniques, processes, functions, components, systems described herein. For example, the apparatus 500 can be used to implement functions of the UE 110 in various embodiments and examples described herein. The apparatus 500 can be a general purpose computer in some embodiments, and can be a device including specially designed circuits to implement various functions, components, or processes described herein in other embodiments. The apparatus 500 can include receiving circuitry 510 and processing circuitry 520.

In an embodiment, the receiving circuitry 510 can be configured to receive a Q number indicating a QCL relation for SSB positions for a cell operating in a shared spectrum, and one or more SSBs within DRS transmission windows associated with the cell. Each of the DRS transmission windows can include a sequence of beam positions each corresponding to a position index, and the SSBs within each of the DRS transmission windows can be transmitted at same or different beam positions for different DRS transmission windows. In some embodiments, the receiving circuitry 510 can receive the Q number by receiving a PBCH that carries the Q number from the cell operating in the shared spectrum in a case that the apparatus 500 has no serving cell. In other embodiment, the receiving circuitry 510 can receive the Q number by receiving a higher layer signaling that carries the Q number from a serving cell in a case that the apparatus 500 has the serving cell. The processing circuitry 520 can be configured to, for each of the DRS transmission windows, decode the SSBs to obtain position indexes corresponding to the SSBs. The processing circuitry 520 can be further configured to perform a modulo operation on the position indexes of the SSBs within a corresponding DRS transmission window with the Q number to determine SBIs of the SSBs within the corresponding DRS transmission window. A remainder of each of the position indexes can be an SBI of one of the SSBs that corresponds to the position index. The processing circuitry 520 can be further configured to combine RRM measurements of the SSBs within the DRS transmission windows based on the SBIs of the SSBs within the DRS transmission windows to determine the quality of the cell operating in the shared spectrum.

In some embodiments, the receiving circuitry 510 can receive the Q number by receiving a PBCH that carries the Q number. For example, the Q number is carried in a MIB of the PBCH. In other embodiments, the receiving circuitry 510 can receive the PBCH that carries the Q number by receiving the PBCH that carries the Q number for the cell operating in the shared spectrum. In various embodiments, the receiving circuitry 510 can receive the PBCH that carries the Q number by receiving the PBCH that carries the Q number from the cell operating in the shared spectrum.

In some embodiment, the receiving circuitry 510 can be further configured for receiving a higher layer signaling that carries the Q number. For example, the higher layer signaling can be a measurement configuration message including a MO that carries the Q number. For example, the MO can further carry a carrier frequency, and the Q number can be applied for all cells operating at the carrier frequency. In other embodiments, the higher layer signaling can be a SIB that carries the Q number. In various embodiments, the receiving circuitry 510 can receive the higher layer signaling that carries the Q number by receiving the higher layer signaling that carries the Q number for the cell operating in the shared spectrum from a serving cell. For example, the serving cell can be the same as or different from the cell operating in the shared spectrum.

In various embodiments according to the disclosure, the receiving circuitry 510 and the processing circuitry 520 can include circuitry configured to perform the functions and processes described herein in combination with software or without software. In various examples, the processing circuitry can be a digital signal processor (DSP), an application specific integrated circuit (ASIC), programmable logic devices (PLDs), field programmable gate arrays (FPGAs), digitally enhanced circuits, or comparable device or a combination thereof.

In some other embodiments according to the disclosure, the processing circuitry 520 can be a central processing unit (CPU) configured to execute program instructions to perform various functions and processes described herein.

The apparatus 500 can optionally include other components, such as input and output devices, additional or signal processing circuitry, and the like. Accordingly, the apparatus 500 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving, at a user equipment (UE), a Q number indicating a quasi co location (QCL) relation for synchronization signal block (SSB) positions for a cell operating in a shared spectrum;
receiving, at the UE, from the cell operating in the shared spectrum one or more SSBs within discovery reference signal (DRS) transmission windows associated with the cell operating in the shared spectrum;
for each of the DRS transmission windows, performing a modulo operation on position indexes of the SSBs within a corresponding DRS transmission window with the Q number to determine SSB beam indexes (SBIs) of the SSBs within the corresponding DRS transmission window, a remainder of each of the position indexes being an SBI of one of the SSBs that corresponds to the position index; and
combining radio resource management (RRM) measurements of the SSBs within the DRS transmission windows based on the SBIs of the SSBs within the DRS transmission windows to determine a quality of the cell operating in the shared spectrum.

2. The method of claim 1, wherein receiving a Q number includes:
receiving a physical broadcast channel (PBCH) that carries the Q number.

3. The method of claim 2, wherein the Q number is carried in a master information block (MIB) of the PBCH.

4. The method of claim 2, wherein receiving a PBCH that carries the Q number includes:
receiving the PBCH that carries the Q number from the cell operating in the shared spectrum.

5. The method of claim 1, wherein receiving a Q number includes:
receiving a higher layer signaling that carries the Q number.

6. The method of claim 5, wherein the higher layer signaling is a measurement configuration message including a measurement object (MO) that carries the Q number.

7. The method of claim 6, wherein the MO further carries a carrier frequency, and the Q number is applied for all cells operating at the carrier frequency.

8. The method of claim 5, wherein the higher layer signaling is a system information block (SIB) that carries the Q number.

9. The method of claim 5, wherein receiving a higher layer signaling that carries the Q number includes:
receiving the higher layer signaling that carries the Q number for the cell operating in the shared spectrum from a serving cell.

10. The method of claim 1, wherein receiving the Q number includes:
in a case that the UE has no serving cell, receiving a PBCH that carries the Q number from the cell operating in the shared spectrum; and
in a case that the UE has a serving cell, receiving a higher layer signaling that carries the Q number from the serving cell.

11. An apparatus, comprising:
receiving circuitry configured for receiving a Q number indicating a QCL relation for SSB positions for a cell operating in a shared spectrum and one or more SSBs within DRS transmission windows associated with the cell; and
processing circuitry configured for, for each of the DRS transmission windows, performing a modulo operation on position indexes of the SSBs within a corresponding DRS transmission window with the Q number to determine SBIs of the SSBs within the corresponding DRS transmission window, a remainder of each of the position indexes being an SBI of one of the SSBs that corresponds to the position index, and combining RRM measurements of the SSBs within the DRS transmission windows based on the SBIs of the SSBs within the DRS transmission windows to determine a quality of the cell operating in the shared spectrum.

12. The apparatus of claim 11, wherein the receiving circuitry receives the Q number by receiving a PBCH that carries the Q number.

13. The apparatus of claim 12, wherein the Q number is carried in a MIB of the PBCH.

14. The apparatus of claim 11, wherein the receiving circuitry receives the PBCH that carries the Q number by receiving the PBCH that carries the Q number from the cell operating in the shared spectrum.

15. The apparatus of claim 11, wherein the receiving circuitry is further configured for receiving a higher layer signaling that carries the Q number.

16. The apparatus of claim 15, wherein the higher layer signaling is a measurement configuration message including a MO that carries the Q number.

17. The apparatus of claim 16, wherein the MO further carries a carrier frequency, and the Q number is applied for all cells operating at the carrier frequency.

18. The apparatus of claim 15, wherein the higher layer signaling is a SIB that carries the Q number.

19. The apparatus of claim 15, the receiving circuitry receives the higher layer signaling that carries the Q number by receiving the higher layer signaling that carries the Q number for the cell operating in the shared spectrum from a serving cell.

20. The apparatus of claim 11, wherein the receiving circuitry receives the Q number by receiving a PBCH that carries the Q number from the cell operating in the shared spectrum in a case that the apparatus has no serving cell, and by receiving a higher layer signaling that carries the Q number from a serving cell in a case that the apparatus has the serving cell.
